(19) United States
(12) Patent Application Publication
(10) Pub. No.: US 2025/0231902 A1
(43) Pub. Date: Jul. 17, 2025

(54) DATA TRANSMISSION METHOD AND APPARATUS THEREOF

(71) Applicant: MEDIATEK INC., Hsinchu City (TW)

(72) Inventors: Yuan-Ming HSIEH, Hsinchu City (TW); Hsin-Hao HUANG, Hsinchu City (TW); Wei-Cheng CHANG, Hsinchu City (TW)

(21) Appl. No.: 19/009,268

(22) Filed: Jan. 3, 2025

Related U.S. Application Data
(60) Provisional application No. 63/620,201, filed on Jan. 12, 2024.

(51) Int. Cl. G06F 13/42

(52) U.S. Cl. CPC G06F 13/4282; G06F 2213/0026

(57) ABSTRACT

A data transmission method is provided. The data transmission method may be applied to an apparatus. The data transmission method may include the following steps. The modem of an apparatus may receive or transmit data packets from or to the host device of the apparatus through a host interface in an event that the modem is in a first mode during the period. Then, the modem may store the data packets in a buffer in an event that the modem is in a second mode during the period. The host interface is in an active mode in an event that the modem is in the first mode, and the host interface is in a low power low-power mode in an event that the modem is in the second mode.

### CROSS REFERENCE TO RELATED APPLICATIONS

This application claims the benefits of U.S. Provisional Application No. 63/620,201 filed on Jan. 12, 2024, the entirety of which is incorporated by reference herein.

### BACKGROUND OF THE INVENTION

### Field of the Invention

The invention generally relates to wireless communications technology, and more particularly, it relates to data transmission through a host interface.

### Description of the Related Art

In conventional data transmission technologies employed to effectuate communication between a modem and a host device, the host interface (e.g., a peripheral component interconnect express (PCIe) interface, a secure digital input/output (SDIO) interface, a universal serial bus (USB) interface, a universal asynchronous receiver/transmitter (UART) interface, etc.) may be woken up from a power-saving mode by the scattered traffic from the host device or modem. Power is required to wake up the host interface, and therefore, the total power consumption may be increased by the host interface being woken up frequently.

In addition, when the host device transmits data (or traffic) to the modem through the host interface, the modem may be in a sleep state (or idle state). The modem may need to be woken up from its sleep state to receive the data from the host device. Therefore, the power consumption may also be increased by frequently waking up the modem.

Therefore, how to reduce the power consumption of the host interface and modem is a topic that is worthy of discussion.

### BRIEF SUMMARY OF THE INVENTION

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is to propose schemes, concepts, designs, systems, methods and apparatus pertaining to data transmission through a host interface with respect to user equipment. It is believed that the above-described issue would be avoided or otherwise alleviated by implementing one or more of the proposed schemes described herein.

An embodiment of the invention provides a data transmission method. The data transmission method may be applied to an apparatus. The data transmission method may include the following steps. A modem of the apparatus may receive or transmit data packets from or to the host device of the apparatus through the host interface in an event that the modem is in a first mode during the period. Then, the modem may store the data packets in a buffer in an event that the modem is in a second mode during the period. The host interface may be in an active mode in an event that the modem is in the first mode, and the host interface may be in a low-power mode in an event that the modem is in the second mode.

In some embodiments, in event the modem enters the next period, the modem may switch from the second mode to the first mode to receive or transmit new packets from or to the host interface, and to transmit the data packet stored in the buffer to the host interface.

In some embodiments, the modem may determine the period according to a timer.

In some embodiments, the modem may transmit a synchronization timer to the host device to align the start time of transmitting the data packets to the host device through the host interface with the start time of receiving the data packets from the host device through the host interface.

In some embodiments, the start time of receiving the data packets from the host device through the host interface may be aligned with at least one modem wake-up event.

In some embodiments, the modem wake-up event may comprise a connected discontinuous reception (CDRX) associated with the apparatus.

In some embodiments, the host interface may comprise a peripheral component interconnect express (PCIe) interface, a secure digital input/output (SDIO) interface, a universal serial bus (USB) interface, or a universal asynchronous receiver/transmitter (UART) interface.

An embodiment of the invention provides an apparatus. The apparatus may comprise a modem or a host device. The modem may be configured to perform wireless transmission and reception to and from a network node. The host device may be coupled to the modem through a host interface. The modem may receive or transmit data packets from or to the host device of the apparatus through the host interface in an event that the modem is in a first mode during the period. The modem may store data packets in a buffer in an event that the modem is in a second mode during the period. The host interface may be in an active mode in an event that the modem is in the first mode, and the host interface is in a low-power mode in an event that the modem is in the second mode.

Other aspects and features of the invention will become apparent to those with ordinary skill in the art upon review of the following descriptions of specific embodiments of the data transmission methods and apparatus.

### BRIEF DESCRIPTION OF THE DRAWINGS

The invention will become more fully understood by referring to the following detailed description with reference to the accompanying drawings, wherein:

FIG. 1 is a block diagram of a wireless communication system 100 according to an embodiment of the application.

FIG. 2 is a block diagram illustrating a communication apparatus according to an embodiment of the application.

FIG. 3 is a block diagram illustrating a network node according to an embodiment of the application.

FIG. 4 is a schematic diagram illustrating a traffic shaping procedure according to an embodiment of the application.

FIG. 5 is a schematic diagram illustrating traffic synchronization for PCIe power-saving according to an embodiment of the application.

FIG. 6 is a schematic diagram illustrating traffic synchronization for modem power-saving according to an embodiment of the application.

FIG. 7 is a flow chart illustrating a data transmission method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

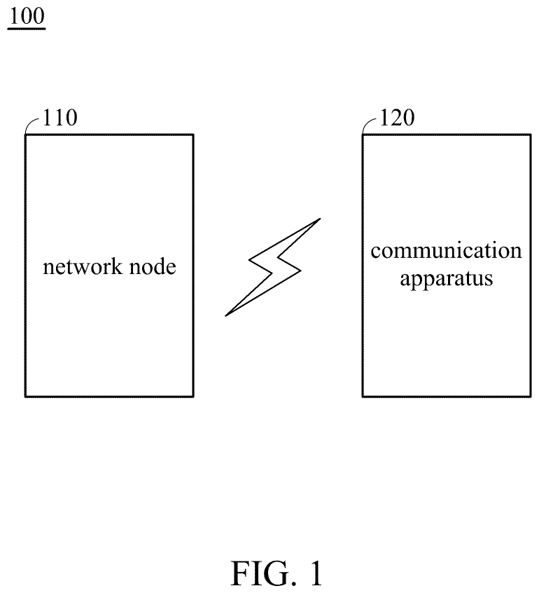

FIG. 1 is a block diagram of a wireless communication system 100 according to an embodiment of the application. As shown in FIG. 1, the wireless communication system 100 may include a network node 110 and a communication apparatus 120. It should be noted that, in order to clarify the concept of the invention, FIG. 1 presents a simplified block diagram in which only the elements relevant to the invention are shown. However, the invention should not be limited to what is shown in FIG. 1.

In an embodiment of the invention, the network node 110 may be a base station, a gNodeB (gNB), a NodeB (NB) an eNodeB (eNB), an access point (AP), an access terminal, a Wi-Fi hotpot, but the invention should not be limited thereto. In an embodiment, the communication apparatus 120 may communicate with the network node 110 through the fourth generation (4G) communication technology, fifth generation (5G) communication technology (or 5G New Radio (NR) communication technology), or sixth generation (6G) communication technology, but the invention should not be limited thereto. In another embodiment, the communication apparatus 120 may be in wireless communication with a wireless network including a non-terrestrial network (NTN) and a TN via the network node 110. That is, the network node 110 may be a terrestrial network node (e.g., an eNB, a gNB, or a transmission/reception point (TRP)) and/or a non-terrestrial network node (e.g., a satellite). For example, the terrestrial network node and/or the non-terrestrial network node may form an NTN serving cell for wireless communication with the communication apparatus 120. In another embodiment, the network node 110 may be an entity compatible with the Institute of Electrical and Electronics Engineers (IEEE) 802.11 standards to provide and manage the access to the wireless medium for the communication apparatus 120.

In the embodiments of the invention, the communication apparatus 120 may be a user equipment (UE), a non-AP station (STA), a smartphone, Personal Data Assistant (PDA), pager, laptop computer, desktop computer, wireless handset, or any computing device that includes a wireless communications interface. In addition, the communication apparatus 120 may be an entity compatible with the Institute of Electrical and Electronics Engineers (IEEE) 802.11 standards.

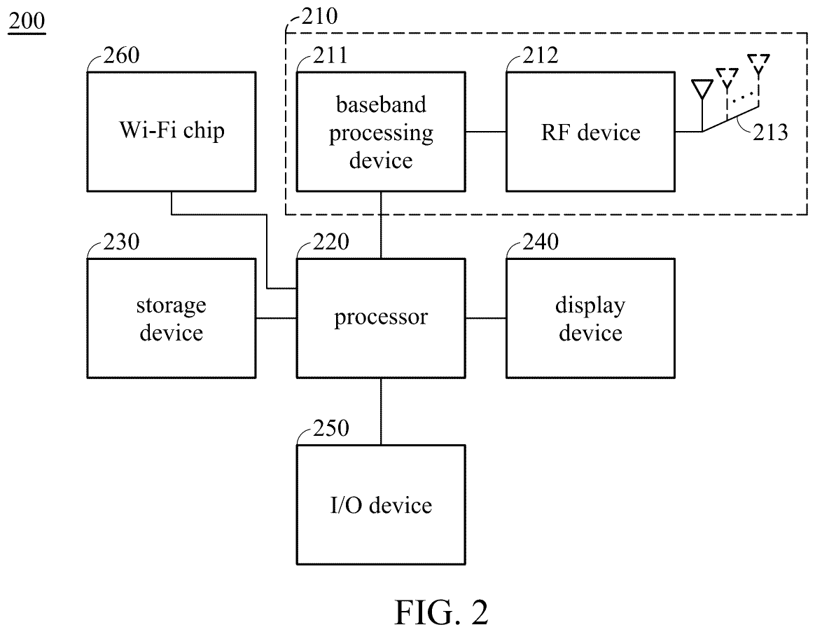

FIG. 2 is a block diagram illustrating a communication apparatus 200 according to an embodiment of the application. The communication apparatus 200 can be applied to the communication apparatus 120. As shown in FIG. 2, the communication apparatus 200 may comprise a wireless transceiver 210, a processor 220, a storage device 230, a display device 240, an Input/Output (I/O) device 250, and a Wi-Fi chip 260.

The wireless transceiver 210 may be configured to perform wireless transmission and reception to and from the communication apparatus 120.

Specifically, the wireless transceiver 210 may include a baseband processing device 211, a Radio Frequency (RF) device 212, and antenna 213, wherein the antenna 213 may include an antenna array for UL/DL MIMO.

The baseband processing device 211 may be configured to perform baseband signal processing, such as Analog-to-Digital Conversion (ADC)/Digital-to-Analog Conversion (DAC), gain adjusting, modulation/demodulation, encoding/decoding, and so on. The baseband processing device 211 may contain multiple hardware components, such as a baseband processor, to perform the baseband signal processing.

The RF device 212 may receive RF wireless signals via the antenna 213, convert the received RF wireless signals to baseband signals, which are processed by the baseband processing device 211, or receive baseband signals from the baseband processing device 211 and convert the received baseband signals to RF wireless signals, which are later transmitted via the antenna 213. The RF device 212 may comprise a plurality of hardware elements to perform radio frequency conversion. For example, the RF device 212 may comprise a power amplifier, a mixer, analog-to-digital converter (ADC)/digital-to-analog converter (DAC), etc.

According to an embodiment of the invention, the RF device 212 and the baseband processing device 211 may collectively be regarded as a radio module capable of communicating with a wireless network to provide wireless communications services in compliance with a predetermined Radio Access Technology (RAT). Note that, in some embodiments of the invention, the communication apparatus 200 may be extended further to comprise more than one antenna and/or more than one radio module, and the invention should not be limited to what is shown in FIG. 2

The processor 220 may be a general-purpose processor, a Central Processing Unit (CPU), a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 210 for wireless communications with the network node 110, storing and retrieving data (e.g., program code) to and from the storage device 230, sending a series of frame data (e.g. representing text messages, graphics, images, etc.) to the display device 240, and receiving user inputs or outputting signals via the I/O device 250.

In particular, the processor 220 coordinates the aforementioned operations of the wireless transceiver 210, the storage device 230, the display device 240, the I/O device 250, and the Wi-Fi chip 260 for performing the method of the present application.

As will be appreciated by persons skilled in the art, the circuits of the processor 220 may include transistors that are configured in such a way as to control the operation of the circuits in accordance with the functions and operations described herein. As will be further appreciated, the specific structure or interconnections of the transistors may be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 230 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data, instructions, and/or program code of applications, communication protocols, and/or the method of the present application.

The display device 240 may be a Liquid-Crystal Display (LCD), a Light-Emitting Diode (LED) display, an Organic LED (OLED) display, or an Electronic Paper Display (EPD), etc., for providing a display function. Alternatively, the display device 240 may further include one or more touch sensors for sensing touches, contacts, or approximations of objects, such as fingers or styluses.

The I/O device 250 may include one or more buttons, a keyboard, a mouse, a touch pad, a video camera, a microphone, and/or a speaker, etc., to serve as the Man-Machine Interface (MMI) for interaction with users.

According to an embodiment of the invention, the Wi-Fi chip 260 may comprise Wi-Fi antenna and may be configured to perform the operations of Wi-Fi communications.

According to an embodiment of the invention, the wireless transceiver 210 may be configured in a modem (MD) of the communication apparatus 200, and the processor 220 may be configured in an application processor (AP) or a host device of the communication apparatus 200. The modem may be coupled to the host device through a host interface. According to an embodiment of the invention, the host interface may comprise a peripheral component interconnect express (PCIe) interface, a secure digital input/output (SDIO) interface, a universal serial bus (USB) interface, or a universal asynchronous receiver/transmitter (UART) interface, but the invention should not be limited thereto.

It should be understood that the components described in the embodiment of FIG. 2 are for illustrative purposes only and are not intended to limit the scope of the application. For example, a communication apparatus may include more components, such as another wireless transceiver for providing telecommunication services, a Global Positioning System (GPS) device for use of some location-based services or applications, and/or a battery for powering the other components of the communication apparatus, etc. Alternatively, a communication apparatus may include fewer components. For example, the communication apparatus 200 may not include the display device 240 and/or the I/O device 250.

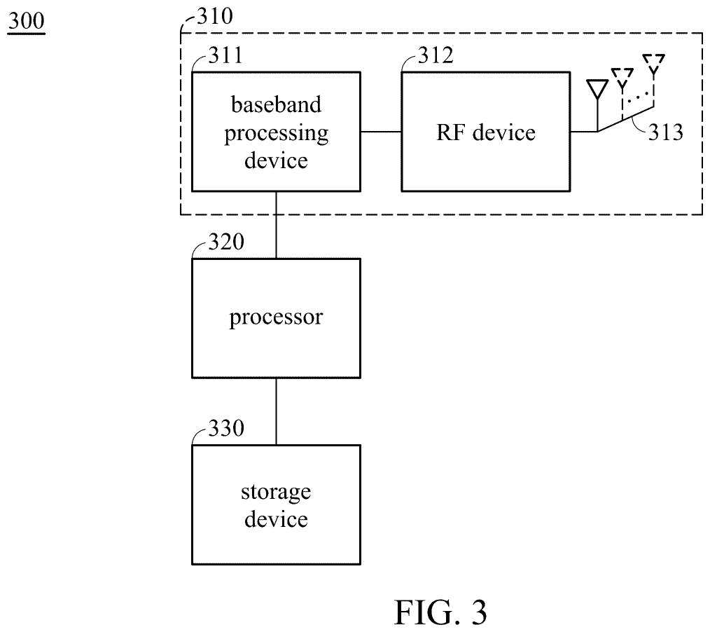

FIG. 3 is a block diagram illustrating a network node 300 according to an embodiment of the application. The network node 300 can be applied to the network node 110. As shown in FIG. 3, the network node 300 may comprise a wireless transceiver 310, a processor 320, and a storage device 330.

The wireless transceiver 310 is configured to perform wireless transmission and reception to and from one or more communication apparatuses (e.g., the communication apparatus 120).

Specifically, the wireless transceiver 310 may include a baseband processing device 311, an RF device 312, and antenna 313, wherein the antenna 313 may include an antenna array for UL/DL MU-MIMO.

The baseband processing device 311 is configured to perform baseband signal processing, such as ADC/DAC, gain adjusting, modulation/demodulation, encoding/decoding, and so on. The baseband processing device 311 may contain multiple hardware components, such as a baseband processor, to perform the baseband signal processing.

The RF device 312 may receive RF wireless signals via the antenna 313, convert the received RF wireless signals to baseband signals, which are processed by the baseband processing device 311, or receive baseband signals from the baseband processing device 311 and convert the received baseband signals to RF wireless signals, which are later transmitted via the antenna 313. The RF device 312 may comprise a plurality of hardware elements to perform radio frequency conversion. For example, the RF device 312 may comprise a power amplifier, a mixer, analog-to-digital converter (ADC)/digital-to-analog converter (DAC), etc.

The processor 320 may be a general-purpose processor, an MCU, an application processor, a DSP, a GPU/HPU/NPU, or the like, which includes various circuits for providing the functions of data processing and computing, controlling the wireless transceiver 310 for wireless communications with the communication apparatus 120, and storing and retrieving data (e.g., program code) to and from the storage device 330.

In particular, the processor 320 coordinates the aforementioned operations of the wireless transceiver 310 and the storage device 330 for performing the method of the present application.

In another embodiment, the processor 320 may be incorporated into the baseband processing device 311, to serve as a baseband processor.

As will be appreciated by persons skilled in the art, the circuits of the processor 320 may include transistors that are configured in such a way as to control the operation of the circuits in accordance with the functions and operations described herein. As will be further appreciated, the specific structure or interconnections of the transistors may be determined by a compiler, such as an RTL compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 330 may be a non-transitory machine-readable storage medium, including a memory, such as a FLASH memory or a NVRAM, or a magnetic storage device, such as a hard disk or a magnetic tape, or an optical disc, or any combination thereof for storing data, instructions, and/or program code of applications, communication protocols, and/or the method of the present application.

It should be understood that the components described in the embodiment of FIG. 3 are for illustrative purposes only and are not intended to limit the scope of the application. For example, a network node may include more components, such as a display device for providing a display function, and/or an I/O device for providing an MMI for interaction with users.

According to an embodiment of the invention, a modem of an apparatus (e.g., communication apparatus 200) may receive data packets from the host device of the apparatus through the host interface, or transmit data packets to the host device through the host device when the modem is in a first mode during a period (e.g., a traffic shaping (TRAS) period or a gating period). Then, the modem may store the data packets in a buffer when the modem is in a second mode during the period. In the embodiment, each period (e.g., TARS period) may comprise a period of time correspond to the first mode of the modem and comprise the other period of time corresponding to the second mode of the modem. According to an embodiment of the invention, the host interface may comprise a PCIe interface, an SDIO interface, a USB interface, or a UART interface, but the invention should not be limited thereto.

When the modem enters the next period (e.g., the next TRAS period), the modem may switch from the second mode to the first mode to receive or transmit new packets from or to the host interface. In addition, in the first mode of the next period, the modem may transmit the data packet stored in the buffer in the previous period to the host interface.

According to an embodiment of the invention, the first mode associated with the modem may be a direct mode. That is, in the direct mode, the modem may perform the transmission or reception with the host device through the host interface. The second mode associated with the modem may be a buffering mode. That is, in the buffering mode, the modem may stop performing the transmission or reception with the host device, and store the data packets which need to be transmitted to the host device in the buffer.

According to an embodiment of the invention, a power state of the host interface may be in an active mode when the modem is in the first mode (i.e., direct mode). When the host interface is in the active mode, the host interface can be used to transmit data packets from the host device to the modem, and/or transmit the data packets from the modem to the host device. In addition, a power state of the host interface may be in a low-power mode (or an idle mode) to save power when the modem is in the second mode (i.e., buffering mode). When the host interface is in the low-power mode, the host interface will be not used to transmit data packets from the host device to the modem, and/or transmit the data packets from the modem to the host device to save power.

According to an embodiment of the invention, the modem may determine the period (e.g., TRAS period) according to a timer (e.g., a TRAS timer). The modem may indicate the timer (e.g., TRAS timer) to the host device. The host device may determine the power state of the host interface (e.g., active mode or low-power mode) according to the timer.

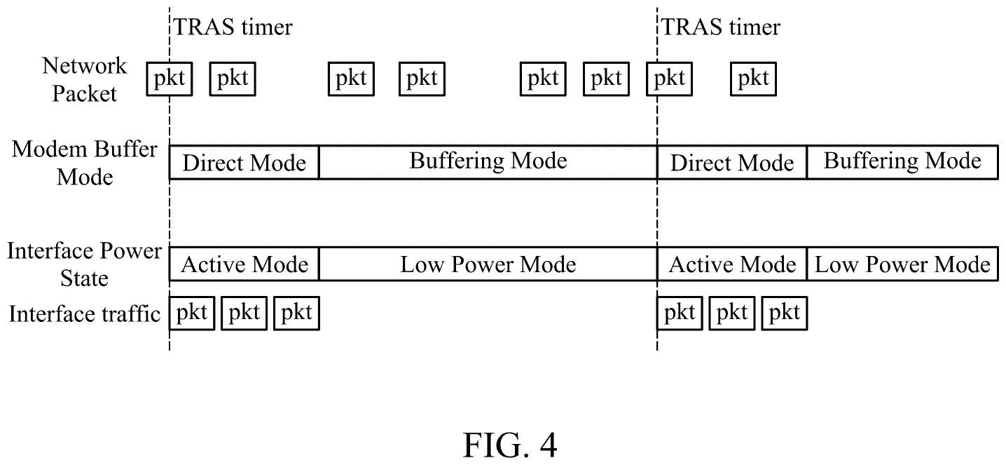

FIG. 4 is a schematic diagram illustrating a traffic shaping procedure according to an embodiment of the application. The traffic shaping procedure may be applied to the network node 110 and the communication apparatus 120 of the wireless communication system 100. As shown in FIG. 4, a TRAS timer (e.g., 10 millisecond (10 ms), but the invention should not be limited thereto) may be used to define a period, i.e., a length of the TRAS timer may one period. When the TRAS timer is started, a modem may enter a direct mode to receive data packets (pkt) from the network node, and then transmit the data packets from the network node to the host device through the host interface. In addition, when the modem is in the direct mode, the host device may switch the power state of the host interface to the active mode. When the power state of the host interface is in the active mode, the modem may perform the data (or traffic) transmission and/or data (or traffic) reception with the host device through the host interface. When the modem switches from the direct mode to the buffering mode during the time of the TRAS timer, the modem may store the data packets from the network node in a buffer, and the host device may switch the power state of the host interface from the active mode to the low-power mode. When the next TRAS timer is started, the modem may switch from the buffering mode to the direct mode to receive data packets from the network node, and then transmit the data packets from the network node to the host device through the host interface. In addition, the modem may also transmit the buffered data packets in the previous period to the host device through the host interface. Accordingly, when the modem switches to the direct mode, the host device may switch the power state of the host interface from the low-power mode to the active mode.

According to an embodiment of the invention, the modem may transmit a synchronization timer to the host device to align the start time of transmitting the data packets to the host device through the host interface with the start time of receiving the data packets from the host device through the host interface. That is, the host device may determine the timing of waking up the host interface according to the synchronization timer. Specifically, when the host device needs to transmit uplink (UL) traffic to the modem, the host device may determine the timing of transmitting the UL traffic according to the synchronization timer. The timing of waking up the host interface may be aligned with the timing of the power state of the modem being the active state to reduce the wake-up time of the host interface. The modem may perform the TRAS operation (or mechanism) discussed above in an event that the power state of the modem is the active state.

In an embodiment, the start time of the modem receiving the data packets from the host device through the host interface may be aligned with at least one modem wake-up event. That is, the host device may know the modem wake-up event according to the synchronization timer. In an example, the modem wake-up event may comprise a connected discontinuous reception (CDRX) scheduling associated with the apparatus.

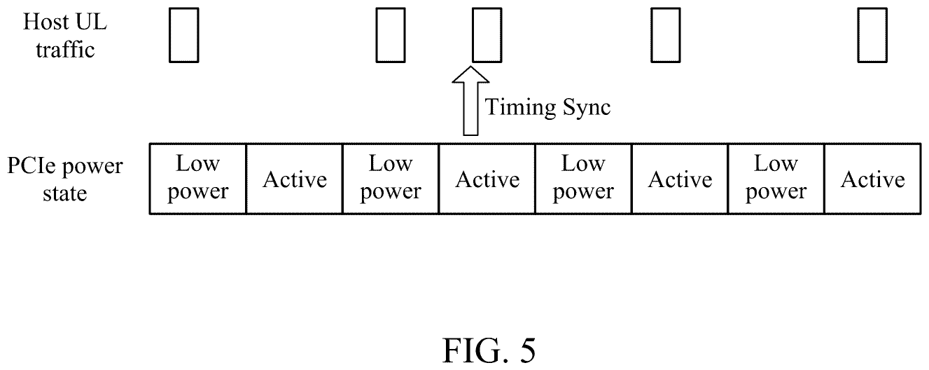

FIG. 5 is a schematic diagram illustrating traffic synchronization for PCIe power-saving according to an embodiment of the application. In the embodiment, a host device may be coupled to a modem through a PCIe interface. As shown in FIG. 5, the timing of the host device transmitting UL traffic to the modem through the PCIe interface may be aligned (or synchronized) the timing of the power state of the PCIe interface being the active state. The PCIe interface may not be woken up to transmit the UL traffic to the modem when the power state of the PCIe interface is the low-power mode (or idle mode). Therefore, the number of waking up the PCIe interface can be reduced to achieve the power-saving of the PCIe interface.

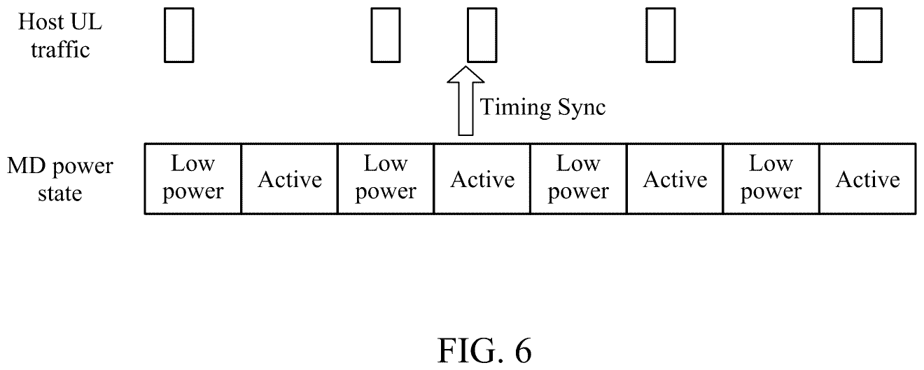

FIG. 6 is a schematic diagram illustrating traffic synchronization for modem power-saving according to an embodiment of the application. In the embodiment, a host device may be coupled to a modem through a PCIe interface. As shown in FIG. 6, the timing of the host device transmitting UL traffic to the modem through the PCIe interface may be aligned (or synchronized) the timing of the power state of the modem being the active state. The modem may not be woken up to receive the UL traffic from the host device through the PCIe interface when the power state of the modem is the low-power mode (or idle mode). Therefore, the number of waking up the modem can be reduced to achieve the power-saving of the modem.

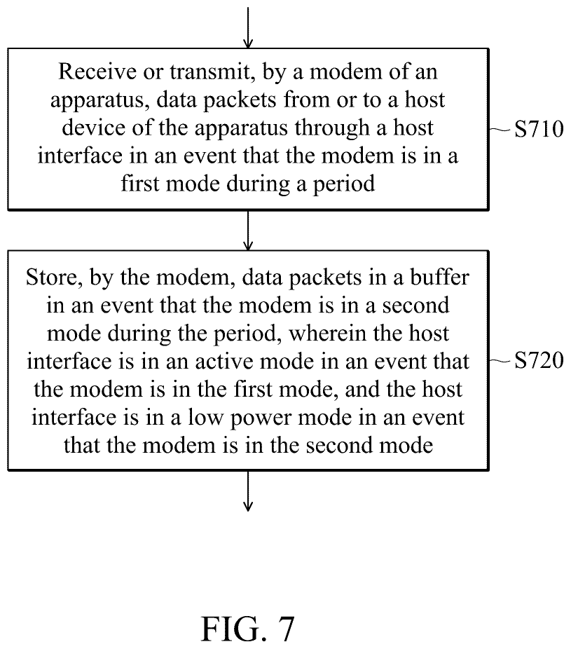

FIG. 7 is a flow chart illustrating a data transmission method according to an embodiment of the invention. The data transmission method can be applied to an apparatus (e.g., the communication apparatus 120 of the wireless communication system 100). As shown in FIG. 7, in step S710, a modem of the apparatus may receive or transmit data packets from or to the host device of the apparatus through the host interface in an event that the modem is in a first mode during the period.

In step S720, the modem may store data packets in a buffer in an event that the modem is in a second mode during the period, wherein the host interface may be in an active mode in an event that the modem is in the first mode, and the host interface may be in a low-power mode in an event that the modem is in the second mode.

According to an embodiment of the invention, in the data transmission method, in event the modem enters the next period, the modem may switch from the second mode to the first mode to receive or transmit new packets from or to the host interface, and to transmit the data packet stored in the buffer to the host interface.

According to an embodiment of the invention, in the data transmission method, the modem may determine the period according to a timer.

According to an embodiment of the invention, in the data transmission method, the modem may transmit a synchronization timer to the host device to align the start time of transmitting the data packets to the host device through the host interface with the start time of receiving the data packets from the host device through the host interface.

According to an embodiment of the invention, in the data transmission method, the start time of receiving the data packets from the host device through the host interface may be aligned with at least one modem wake-up event.

According to an embodiment of the invention, in the data transmission method, the modem wake-up event may comprise a connected discontinuous reception (CDRX) associated with the apparatus.

According to an embodiment of the invention, in the data transmission method, the host interface may comprise a PCIe interface, an SDIO interface, a USB interface, or a UART interface.

According to the data transmission method provided in the embodiments of the invention, the number of waking up the host interface can be reduced. In addition, according to the data transmission method provided in the embodiments of the invention, the timing of waking up the host interface may be aligned with the timing of the modem being the active mode. Therefore, the power saving for the host interface and the modem can be achieved.

Use of ordinal terms such as “first”, “second”, “third”, etc., in the disclosure and claims is for description. It does not by itself connote any order or relationship.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in the UE. In the alternative, the processor and the storage medium may reside as discrete components in the UE. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it should be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data transmission method, comprising:
receiving or transmitting, by a modem of an apparatus, data packets from or to a host device of the apparatus through a host interface in an event that the modem is in a first mode during a period; and
storing, by the modem, data packets in a buffer in an event that the modem is in a second mode during the period,
wherein the host interface is in an active mode in an event that the modem is in the first mode, and the host interface is in a low-power mode in an event that the modem is in the second mode.

2. The data transmission method of claim 1, further comprising:
in event the modem enters a next period, switching, by the modem, from the second mode to the first mode to receive or transmit new packets from or to the host interface, and to transmit the data packet stored in the buffer to the host interface.

3. The data transmission method of claim 1, further comprising:
determining, by the modem, the period according to a timer.

4. The data transmission method of claim 1, further comprising:
transmitting, by the modem, a synchronization timer to the host device to align a start time of transmitting the data packets to the host device through the host interface with a start time of receiving the data packets from the host device through the host interface.

5. The data transmission method of claim 4, wherein the start time of receiving the data packets from the host device through the host interface is aligned with at least one modem wake-up event.

6. The data transmission method of claim 5, wherein the at least one modem wake-up event comprises a connected discontinuous reception (CDRX) associated with the apparatus.

7. The data transmission method of claim 1, wherein the host interface comprises a peripheral component interconnect express (PCIe) interface, a secure digital input/output (SDIO) interface, a universal serial bus (USB) interface, or a universal asynchronous receiver/transmitter (UART) interface.

8. An apparatus, comprising:
a modem, configured to perform wireless transmission and reception to and from a network node; and
a host device, coupled to the modem through a host interface,
wherein the modem receives or transmits data packets from or to the host device of the apparatus through a host interface in an event that the modem is in a first mode during a period,
wherein the modem stores data packets in a buffer in an event that the modem is in a second mode during the period,
wherein the host interface is in an active mode in an event that the modem is in the first mode, and the host interface is in a low-power mode in an event that the modem is in the second mode.

9. The apparatus of claim 8, wherein in event the modem enters a next period, the modem switches from the second mode to the first mode to receive or transmit new packets from or to the host interface, and to transmit the data packet stored in the buffer to the host interface.

10. The apparatus of claim 8, wherein the modem determines the period according to a timer.

11. The apparatus of claim 8, wherein the modem transmits a synchronization timer to the host device to align a start time of transmitting the data packets to the host device through the host interface with a start time of receiving the data packets from the host device through the host interface.

12. The apparatus of claim 11, wherein the start time of receiving the data packets from the host device through the host interface is aligned with at least one modem wake-up event.

13. The apparatus of claim 12, wherein the at least one modem wake-up event comprises a connected discontinuous reception (CDRX) associated with the apparatus.

14. The apparatus of claim 8, wherein the host interface comprises a peripheral component interconnect express (PCIe) interface, a secure digital input/output (SDIO) interface, a universal serial bus (USB) interface, or a universal asynchronous receiver/transmitter (UART) interface.
